(19) United States
(12) Patent Application Publication
(10) Pub. No.: US 2017/0126583 A1
(43) Pub. Date: May 4, 2017

(54) METHOD AND ELECTRONIC DEVICE FOR BANDWIDTH ALLOCATION BASED ON ONLINE MEDIA SERVICES

(71) Applicants: LE HOLDINGS (BEIJING) CO., LTD., Beijing (CN); LECLOUD COMPUTING CO., LTD., Beijing (CN)

(72) Inventor: Yangang Xia, Beijing (CN)

(21) Appl. No.: 15/248,842

(22) Filed: Aug. 26, 2016

Related U.S. Application Data
(63) Continuation of application No. PCT/CN2016/082831, filed on May 20, 2016.

(30) Foreign Application Priority Data
Nov. 3, 2015 (CN) 201510736396.0

(51) Int. Cl. H04L 12/911; H04L 12/927

(52) U.S. Cl. CPC H04L 47/781; H04L 47/808

(57) ABSTRACT

Disclosed are a method and system for bandwidth allocating based on online media services, the method including: categorizing users into a plurality of categories according to users' attributes, assigning a measurement interval corresponding to each category, and providing a measurement value corresponding to each sub-category of each category according to the measurement interval; counting the measurement value of current accessing user in reference to the plurality of sub-categories of the plurality of categories and determining an overall score of the accessing users; comparing the overall score of the accessing users with a predetermined scoring/bandwidth model, determining an amount of bandwidth allocation of the accessing user and allocating bandwidth to the user. Thus, the disclosure provides techniques to determine online network bandwidth allocation according to different users, and provides users with better service and better quality assurance.

### CROSS REFERENCE TO RELATED APPLICATIONS

This application is a continuation of International Application No. PCT/CN2016/082831, filed on May 20, 2016, which is based upon and claims priority to Chinese Patent Application No. 201510736396.0, filed on Nov. 3, 2015, the entire contents of each of which are incorporated herein by reference.

### TECHNICAL FIELD

The disclosure relates to the field of Internet information communication and, in particular, to a method and an electronic device for bandwidth allocating based on online media services.

### BACKGROUND

With developments in network technology, more and more business is conducted over networks. For Internet services, bandwidth allocation of services has become an important indicator to measure user's experience, and has garnered increasing attention. Thus, the appropriate allocation and efficient utilization of resources has become a very important issue, as different scenarios have different application requirements.

Conventionally, the access level of different users accessing same resource is typically simplex and fixed, and a designated category cannot be allocated to users with a specific category. When multiple users request for bandwidth resource from a service provider, normally equal network bandwidth resource is allocated to those users. However, due to different circumstances such as users' locations, network utilization, etc., each user's demand for network bandwidth may vary, which leads to an issue that some users do not have adequate service bandwidth, while other user may have excessive service bandwidth.

Currently, online media services have great demand for service bandwidth. For example a large number of users may listen to online music and video for entertainment. And media filed such as music and video files have a much larger size compared to text files and typically have a long play time. As a result, a high demand for service bandwidth quality is placed on service providers. If bandwidth is insufficient, users will experience significant waiting times during listening and/or playback.

For example, if each user streaming a movie is allocated equal bandwidth by a video site, which by default allows users to watch standard-definition video. Users in Beijing may enjoy greater network bandwidth, and thus can watch high-definition video, while users in Ningxia, on the other hand, may have a smaller network bandwidth and hence can only watch standard-definition video. However, due to the equal service bandwidth being allocated. Beijing's users are allocated with excess network bandwidth as they are provided with only standard-definition video by default (although they can enjoy higher-quality high-definition video). On the other hand, Ningxia's users have to suffer frequent buffering and waiting when watching video due to insufficient network bandwidth, even they are provided with standard-definition video.

### SUMMARY

In order to solve the problem of a poor user experience caused by inappropriate bandwidth allocation and utilization of online media services, an embodiment of the disclosure provides a method for bandwidth allocation based on online media services including: categorizing users into a plurality of categories according to users' attributes, assigning a measurement interval corresponding to each category, and providing a measurement value corresponding to each sub-category of each category according to the measurement interval; counting the measurement value of a current access user in reference to the plurality of sub-categories of the plurality of categories, and determining an overall score of the accessing user, comparing the overall score of the accessing user with a predetermined scoring/bandwidth model, determining an amount of bandwidth allocation of the access user, and allocating a bandwidth to the user.

In another embodiment of the disclosure, an electronic device is provided. The electronic device may include at least one processor, and a memory communicably connected with the at least one processor having instructions stored therein executable by the at least one processor, wherein execution of the instructions by the at least one processor causes the at least one processor to execute the method for bandwidth allocation based on online media services mentioned above.

In yet another embodiment of the disclosure, a non-transitory computer-readable storage medium is provided having executable instructions stored therein that, when executed by an electronic device, cause the electronic device to execute the method for bandwidth allocation based on online media services mentioned above

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for bandwidth allocating based on online media services according to an embodiment of the disclosure;

FIG. 2 shows a detailed implementation of one specific embodiment of step 102 of the method shown in FIG. 1;

FIG. 3 is a detailed implementation of another specific embodiment of step 102 of the method shown in FIG. 1;

FIG. 4 is a schematic diagram of a system for bandwidth allocating based on online media services according to an embodiment of the disclosure;

FIG. 5 is an architecture diagram of implementing the method and system for bandwidth allocating based on online media services according to an embodiment of the disclosure; and

FIG. 6 is an architecture diagram of an electronic device or a server of the method for bandwidth allocating based on online media services according to an embodiment of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but do not include all possible not all embodiments. Based on the embodiments of the disclosure, other embodiments obtained by the ordinary skill in the art without undue experimentation are within the scope of the disclosure.

It should be noted that, embodiments of the present application and the technical features involved therein may be combined with each other inasmuch as they are not in conflict with one other.

According to OSI (Open System Interconnect), network communication is divided into seven layers, namely, a physical layer, a data link layer, a network layer, a transport layer, a session layer, a presentation layer, and an application layer. Embodiments of the disclosure provide a method for implementing bandwidth allocation in the network dispatching server. This method may function, for example, in the application layer to facilitate control of the transmission of multimedia data at the source, so as to solve the aforementioned problems associated with wasting network resources and bandwidth.

FIG. 1 is a flow chart of a method for bandwidth allocating based on online media services according to an embodiment of the disclosure. Referring to FIG. 1, which illustrates a method for bandwidth allocating based on online media services according to an embodiment of the disclosure, the method includes the following steps.

Step 101: The network dispatching center categorizes users into a plurality of categories according to users' attributes, assigns a measurement interval corresponding to each category, and provides a measurement value corresponding to each sub-category of each category according to the measurement interval;

Step 102: The network dispatching center counts the measurement value of current accessing user in reference to the plurality of sub-categories of the plurality of categories, and determines an overall score of the accessing users:

Step 103: The network dispatching center compares the overall score of the access users with a predetermined scoring/bandwidth model, determines an amount of bandwidth allocation of the access user, and allocates bandwidth to the user.

The predetermined scoring/bandwidth model, for example, is a table set based on users' history of bandwidth usage and the users' category. The table is stored in the database and is invoked during operation for making a comparison between an overall score of the accessing user and the table to determine bandwidth allocation of the accessing user. Furthermore, the predetermined scoring/bandwidth model can also be updated periodically or on demand to improve the accuracy of the model.

The plurality of categories in the above Step 101, for example, may include at least one of a geographical category, a terminal category, a network category, an end-user category, and a third-party cooperation unit category.

To provide an illustrative example, sub-categories of the geographical category may be divided into Beijing, Shanghai, Guangzhou, Shenzhen, Tianjin, etc. according to provinces. Sub-categories of the terminal category may be divided into the access users using an Apple phone, an Android phone (which may be further subdivided, for example, into high-end, mid-end and low-end machines), tablet PCs, desktop computers and other terminals. Sub-categories of the end-users category may also be divided into non-registered users, registered users, ordinary members, platinum members, gold members, and diamond members, etc. Sub-categories of the network category may be divided into mobile network users. China Unicom network users, telecommunications network and users using other network. The third-party cooperation unit category may be divided into each cooperated third-party cooperation unit.

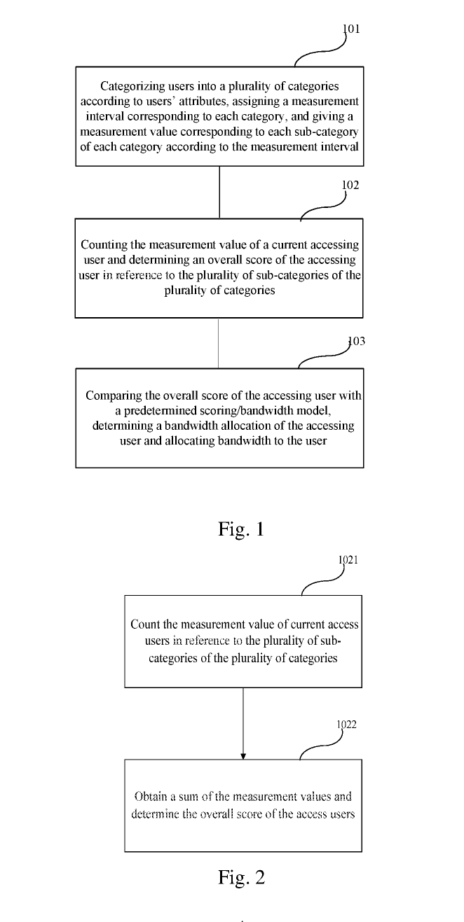

FIG. 2 shows a detailed implementation of one specific embodiment of Step 102 of the method shown in FIG. 1. With respect to the specific execution, in an embodiment, Step 102 may include, for example, the following sub-steps, as shown in FIG. 2.

Step 1021: The network dispatching center counts the measurement value of current accessing users in reference to the plurality of sub-categories of the plurality of categories; and

Step 1022: The network dispatching center sums the measurement values and determines the overall score for the accessing users.

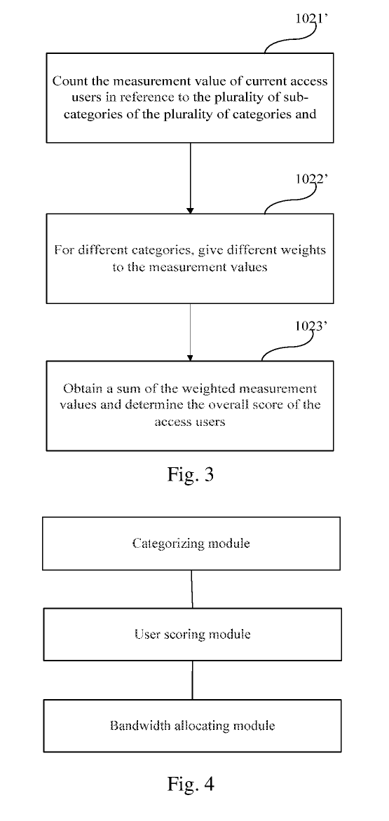

FIG. 3 is a detailed implementation of another specific embodiment of Step 102 of the method shown in FIG. 1. With respect to the execution, in an alternate embodiment, Step 102 may include, for example, the following sub-steps, as shown in FIG. 3.

Step 1021′: The network dispatching center counts the measurement value of a current access user in reference to the plurality of sub-categories of the plurality of categories; and

Step 1022′: The network dispatching center assigns different weights to the measurement values for different categories; and

Step 1023′: The network dispatching center sums the weighted measurement values and determines the overall score of the accessing users.

In an embodiment, the weight is a variable capable of being individually configured, and may be individually configured according to a historical performance of the users.

To provide another illustrative example, accessing users from Beijing. Shanghai, Guangzhou, Shenzhen, and Harbin under the geographical category are given a weight value of 10, 9, 8, 7, and 6, respectively. Similarly, accessing users of the terminal category, product category, user category, and company category are also given different weight values.

In an embodiment, the weight value is configured to be adjustable based on circumstances of the current particular state. For example, Wakin Chau's concert may be held in Beijing from 6:00 PM to 10:00 PM on the 19^{th} of a certain month, and the concert may be broadcasted live on the Internet. However, because the users in Guangzhou, Shenzhen, and Harbin may not prefer to watch Wakin Chau's live concert, while users in Beijing and Shanghai are huge fans of Wakin Chau's live concert and would never miss it, network bandwidth utilization of users in Beijing and Shanghai is heavy, while users in Guangzhou, Shenzhen, and Harbin may have excess network bandwidth.

Continuing this example, the weight value of accessing users in Beijing and Shanghai should increase by 1, while the weight value of accessing users in Guangzhou, Shenzhen, and Harbin should be reduced by 1. Then, the weight values of Beijing, Shanghai, Guangzhou, Shenzhen, and Harbin will be restored to its previous state automatically until the concert ends and tension of network bandwidth utilization in Beijing and Shanghai is relieved.

As a further variation of the above embodiment, if the tension of the network bandwidth usage in Beijing and Shanghai is not yet been relieved, the weight value of accessing users in Beijing and Shanghai will increase by 1 again, and then the weight value of the accessing users in Guangzhou. Shenzhen, and Harbin will be further decreased by 1, until the network bandwidth tension in Beijing and Shanghai is relieved. Of course, the cities of Beijing. Shanghai. Guangzhou, Shenzhen, and Harbin are used as an example and not a limitation, and the embodiments described herein may leverage any suitable number and/or type of categories. Further continuing this example, not only is the network bandwidth shortage in Beijing and Shanghai relieved, but the waste of network bandwidth resources in the cities such as Guangzhou. Shenzhen, and Harbin can be avoided, to allow for better utilization of the network bandwidth resources.

Real-time applications typically require zero (or nearly zero) delay and a specific amount of bandwidth, so a high score will be given to the key users to assign them with the highest bandwidth allocation priority to ensure service quality. For non-critical user, however, a low score may be provided to make the users obtain low bandwidth allocation priority, so that when requests from other users arise, requests from users with lower bandwidth allocation priority may be delayed or discarded, thereby helping the network to release from peak hours under certain circumstances.

As a further variation of the above embodiment, giving the weight value may further includes the following steps.

When a response is made to a user's request, if the bandwidth request cannot be met, it is determined whether there is a user request with a lower score being responded to. If so, the weight value of the user with the lowest score will be reduced, and the bandwidth will be reallocated to the accessing users according to a sum of new measurement performance value and a determined final score, until the request on the bandwidth to be used by the higher score user is met.

Further, when processing of a user's request is delayed at any time, the network bandwidth priority of the user under a category will be increased by 1 or more levels, and then the user is placed in a queue with an increased priority, waiting for processing of its request.

A further improvement based on the above bandwidth allocation method for online media play, the weight values may be configured in the following way.

When there are a number of new user requests arriving simultaneously, it is determined whether the user's bandwidth allocation priority of a new request is higher than that of requests in the current service queue. If so, the new request will access the service. Otherwise it is delayed and placed in a queue to wait for next process.

In the above embodiments, the method for bandwidth allocating based on online media playing provided by the network dispatching center (the network dispatching center is a server or server cluster) fully considers the bandwidth allocation demand of various services applied by those users with high bandwidth allocation priority for their usage experience, and ensures the operation quality, which is very important to experiences of these users with high bandwidth allocation priority. The method achieves an intelligent bandwidth allocation, assures the user experience, and avoids adverse effects on user experience due to inappropriate bandwidth allocation.

In an embodiment, a method for bandwidth allocation is provided based on online media playing. In accordance with such embodiments, a network dispatching center sets a plurality of categories for determining bandwidth allocation priority, and provides an appropriate measurement interval for each category. An overall score of the accessing user is determined according to a measurement performance value of the accessing user in the measurement interval under each category. The overall score of the accessing user is then compared with a predetermined scoring/bandwidth model to determine a bandwidth allocation for the accessing user, thereby reserving different bandwidth resources for different accessing users. The method can realize a targeted allocation of a relatively appropriate bandwidth to different users, thus facilitating a reasonable allocation of bandwidth resources.

Furthermore, the above embodiment for bandwidth allocating based on online media services may include allocating corresponding bandwidth to users according to their different demands for bandwidth, thus it will not result in a waiting of user requests and network congestion due to the over-allocation (service bandwidth is high and user bandwidth is low), nor will it result in an under utilization of user bandwidth resource due to lesser allocation (service bandwidth is low and user bandwidth is high), which avoids a waste of the bandwidth resource and provides a better service and quality assurance to users.

FIG. 4 is a schematic diagram of a system for bandwidth allocating based on online media services according to an embodiment of the disclosure. In an embodiment, the system may include, for example:

a categorizing module configured to categorize users into a plurality of categories according to users' attributes, assign a measurement interval corresponding to each category, and provide a measurement value corresponding to each sub-category of each category according to the measurement interval;

a user scoring module configured to count the measurement value of current accessing user in reference to the plurality of sub-categories of the plurality of categories, and to determine an overall score of the accessing users;

a bandwidth allocating module configured to compare the overall score of the accessing users with a predetermined scoring/bandwidth model, to determine respective bandwidth to be allocated for the accessing users, and allocate accordingly respective bandwidth to the users.

In various embodiments, the plurality of categories in parameter configuration mentioned above may include at least one of a geographical category, a terminal category, a network category, an end-user category, and a third-party cooperation unit category.

In an embodiment, the above user scoring module is configured to count the measurement value of current accessing user in reference to the plurality of sub-categories of each of the plurality of categories, and to determine an overall score of the accessing users, which includes the process of counting the measurement value of current accessing users in reference to the plurality of sub-categories of the plurality of categories, and obtaining (e.g., calculating) a sum of the measurement values, and determining the overall score of the accessing users.

The above user scoring module may be additionally configured to count the measurement value of current accessing users in reference to the plurality of sub-categories of the plurality of categories, and to determine an overall score of the accessing users by conducting the following process of counting the measurement value of a current accessing user in reference to the plurality of sub-categories of the plurality of categories, for different categories, giving different weights to the measurement values, getting a sum of the weighted measurement values, and determining the overall score of the accessing user.

In an embodiment, the weight mentioned above is a variable capable of being individually configured.

In various embodiments, the network dispatching center in the system for bandwidth allocating based on online media playing described herein may be implemented as any suitable number and/or type of computing device. For example, the network dispatching center may be implemented as a server or server cluster, wherein each module can be a standalone server or server cluster. In accordance with such embodiments, the interactions among the modules are the interactions among the servers or server clusters corresponding to each module. The multiple servers or server clusters may constitute the system for bandwidth allocating based on online media playing of the disclosure.

In an embodiment, the system for bandwidth allocating based on online media playing of the disclosure constituted by multiple servers or server clusters includes:

a categorizing server or server cluster configured to categorize users into a plurality of categories according to users' attributes, assign a measurement interval corresponding to each category, and provide a measurement value corresponding to each sub-category of each category according to the measurement interval;

a user scoring server or server cluster configured to count the measurement value of a current accessing user in reference to the plurality of sub-categories of the plurality of categories, and determine an overall score of the accessing user;

a bandwidth allocating server or server cluster configured to compare the overall score of the accessing user with a predetermined scoring/bandwidth model, determine an amount of bandwidth allocation of the accessing user, and allocate bandwidth to the user.

In an alternate embodiment, one or more modules from among the plurality of modules may constitute a server or server cluster together. For example, the categorizing module and user scoring module may together form the first server or the first server cluster, and the bandwidth allocating module may form a second server or a second server cluster.

In this case, interactions among the modules are interactions among the first server to a third server or the interactions among the first server cluster and the second server cluster, the first server to the third server or the first server cluster, and the second server cluster may constitute a system for bandwidth allocation based on online media playing as described herein.

In an embodiment, the system for bandwidth allocating based on online media playing in the above embodiments may fully consider the bandwidth allocation demand of various services applied by those users with high bandwidth allocation priority for their usage experience, and ensures the operation quality, which is very important to experiences of those users with high bandwidth allocation priority. The method achieves an intelligent bandwidth allocation, assures the user experience, and avoids adverse effects on user experience due to inappropriate bandwidth allocation.

Based on the system for bandwidth allocating based on online media playing of the disclosure, a reservation of different bandwidth resources for different accessing users can be realized through cooperation of the categorizing module, the user scoring module, and the bandwidth allocating module. In this way, targeted allocation of a relatively appropriate bandwidth may be facilitated to different users and a reasonable allocation of the bandwidth resources may be realized.

The above method for bandwidth allocating based on online media services allocates corresponding bandwidth to users according to their different demands for bandwidth, thus it will not result in a waiting of user requests and network congestion due to the over-allocation (service bandwidth is high and user bandwidth is low), nor will it result in an under utilization of user bandwidth resource due to a lesser allocation (service bandwidth is low and user bandwidth is high), which avoids a waste of the bandwidth resource and provides a better service and quality assurance to users.

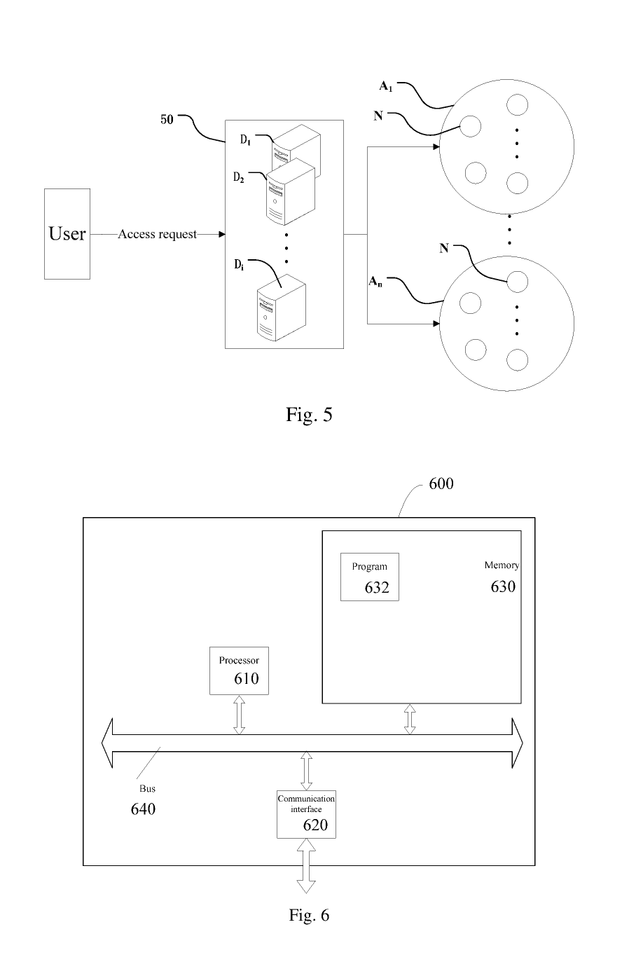

FIG. 5 is an architecture diagram of implementing the method and system for bandwidth allocating based on online media services according to an embodiment of the disclosure. As shown in FIG. 5, in an embodiment, the method and system includes a network dispatching center 50, and any suitable number N of areas A1 to An. The network dispatching center 50 includes any suitable number i of servers D1˜Di. Each of area A1 to area An respectively includes any suitable number of edge CDN nodes N for providing streaming media services to users. In an embodiment, after the server in the network dispatch center of the architecture diagram receives the access request sent by a user through a client terminal (the client terminal is at least an intelligent terminal), the server implements the method for bandwidth allocating based on online media playing as shown in FIG. 1 as discussed herein to allocate an appropriate bandwidth to the user.

The above method and system for bandwidth allocating based on online media services allocates different service bandwidth resources to different accessing users by setting categories for users, to score their bandwidth allocation priorities and to allocate the bandwidth based on the score. In this way, targeted allocation of a relatively appropriate bandwidth may be facilitated to different users and a reasonable allocation of the bandwidth resources may be realized.

Furthermore, the above method and system for bandwidth allocation based on online media services may allocate corresponding bandwidth to users according to their different demands for bandwidth, thus avoiding not only long waiting of user requests and network congestion due to the over-allocation (service bandwidth is high and user bandwidth is low), but also an under utilization of user bandwidth resource due to a lesser allocation (service bandwidth is low and user bandwidth is high), which avoids a waste of the bandwidth resource and provides a better service and quality assurance to users.

In an embodiment of the disclosure, a non-transitory computer-readable storage medium is provided having executable instructions stored therein that, when executed by an electronic device, cause the electronic device to execute the method for bandwidth allocating based on online media services mentioned above.

FIG. 6 is an architecture diagram of an electronic device or a server of the method for bandwidth allocating based on online media services according to an embodiment of the disclosure. Network dispatching server 600, as shown in FIG. 6, is an example of one implementation to facilitate the embodiments discussed herein, although the embodiments are not limited to the specific implementation of the server 600. As shown in FIG. 6, the electronic device or the server 600 may include a processor 610, a communication interface 620, a memory 630, and a communication bus 640.

The processor 610, the communication interface 620, and memory 630 communicate with each other via the communication bus 640. The communication interface 620 may be used to communicate with the network elements such as client ends. Processor 610 may be used to execute program 632, and specifically, to execute the related steps in one or more embodiments as described herein. In an embodiment, program 632 may include program code, and the program code may include computer operation instructions.

In various embodiments, processor 610 may be implemented as any suitable number and/or type of processors. For example, processor 610 may be implemented as a central processing unit CPU or Application Specific Integrated Circuit ASIC, or may be configured as one or more parts of one or more integrated circuits.

In an embodiment, the server may include a memory (e.g., memory 630) configured to store computer operation instructions and a processor (e.g., processor 610) for executing the computer operation instructions stored in the memory, to perform or otherwise execute steps such as, for example:

categorizing users into a plurality of categories according to users' attributes, assigning a measurement interval corresponding to each category, and providing a measurement value corresponding to each sub-category of each category according to the measurement interval;

counting the measurement value of a current accessing user in reference to the plurality of sub-categories of the plurality of categories, and determining an overall score of the accessing user;

comparing the overall score of the accessing user with a predetermined scoring/bandwidth model, determining an amount of bandwidth allocation of the accessing user, and allocating bandwidth to the user.

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are provided to describe the technical solutions of the disclosure, but are not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method in an electronic device for bandwidth allocation based on online media services, comprising:
categorizing, by the electronic device, users into a plurality of categories according to users' attributes;
assigning, by the electronic device, a measurement interval corresponding to each category;
providing, by the electronic device, a measurement value corresponding to each sub-category of each category according to the measurement interval;
counting, by the electronic device, the measurement value of a current accessing user in reference to the plurality of sub-categories of each of the plurality of categories;
determining, by the electronic device, an overall score of the accessing user;
comparing, by the electronic device, the overall score of the accessing user with a predetermined scoring/bandwidth model;
determining, by the electronic device, a bandwidth allocation of the accessing user; and
allocating, by the electronic device, bandwidth to the user.

2. The method of claim 1, wherein the act of counting the measurement value of the current accessing user and determining an overall score of the accessing use comprises:
counting the measurement value of the current accessing user in reference to the plurality of sub-categories of the plurality of categories; and
obtaining a sum of the measurement values;
determining the overall score of the accessing user.

3. The method of claim 1, wherein the act of counting the measurement value of current accessing user in reference to the plurality of sub-categories of the plurality of categories and determining an overall score of the accessing users comprises:
counting the measurement value of the current accessing user in reference to the plurality of sub-categories of the plurality of categories;
for different categories, providing different weights to the measurement values;
obtaining a sum of the weighted measurement values; and
determining the overall score of the accessing user.

4. The method of claim 3, wherein the weight is a variable capable of being individually configured.

5. The method of claim 1, wherein the plurality of categories comprises at least one of geographical category, a terminal category, a network category, an end-user category, and a third-party cooperation unit category.

6. An electronic device, comprising:
at least one processor, and
a memory communicably connected with the at least one processor having instructions stored therein executable by the at least one processor, wherein execution of the instructions by the at least one processor causes the at least one processor to:
categorize users into a plurality of categories based on users' attributes;
assign a measurement interval corresponding to each category;
provide a measurement value corresponding to each sub-category of each category according to the measurement interval;
count the measurement value of a current accessing user in reference to the plurality of sub-categories of each of the plurality of categories;
determine an overall score of the accessing user,
compare the overall score of the accessing user with a predetermined scoring/bandwidth model;
determine an amount of bandwidth allocation of the accessing user; and
allocate bandwidth to the user.

7. The electronic device of claim 6, wherein execution of the instructions by the at least one processor further causes the at least one processor to count the measurement value of a current accessing user and to determine an overall score of the accessing user by performing the steps of:
counting the measurement value of the current accessing user in reference to the plurality of sub-categories of the plurality of categories;
obtaining a sum of the measurement values; and
determining the overall score of the accessing user.

8. The electronic device of claim 6, wherein execution of the instructions by the at least one processor further causes the at least one processor to count the measurement value of the current accessing user and to determine an overall score of the accessing user by the steps of:
counting the measurement value of the current accessing user in reference to the plurality of sub-categories of the plurality of categories;
for different categories, providing different weights to the measurement values;
obtaining a sum of the weighted measurement values; and
determining the overall score of the accessing user.

9. The electronic device of claim 8, wherein the weight is a variable capable of being individually configured.

10. The electronic device of claim 6, wherein the plurality of categories comprises at least one of geographical category, a terminal category, a network category, an end-user category, and a third-party cooperation unit category.

11. A non-transitory computer-readable storage medium storing executable instructions that, when executed by one or more processors associated with an electronic device, cause the electronic device to:
categorize users into a plurality of categories based on users' attributes;
assign a measurement interval corresponding to each category;
provide a measurement value corresponding to each sub-category of each category according to the measurement interval:
count the measurement value of a current accessing user in reference to the plurality of sub-categories of each of the plurality of categories;
determine an overall score of the accessing user,
compare the overall score of the accessing user with a predetermined scoring/bandwidth model;
determine an amount of bandwidth allocation of the accessing user; and
allocate bandwidth to the user.

12. The non-transitory computer-readable storage medium of claim 11, wherein execution of the instructions by the one or more processors further causes the electronic device to count the measurement value of a current accessing user and to determine an overall score of the accessing user by performing the steps of:
counting the measurement value of the current accessing user in reference to the plurality of sub-categories of each of the plurality of categories;
obtaining a sum of the measurement values; and
determining the overall score of the accessing user.

13. The non-transitory computer-readable storage medium of claim 11, wherein execution of the instructions by the one or more processors further causes the electronic device to count the measurement value of the current accessing user and to determine an overall score of the accessing user by performing the steps of:
counting the measurement value of the current accessing user in reference to the plurality of sub-categories of each of the plurality of categories;
for different categories, provide different weights to the measurement values;
obtain a sum of the weighted measurement value; and
determine the overall score of the accessing user.

14. The non-transitory computer-readable storage medium of claim 13, wherein the weight is a variable capable of being individually configured.

15. The non-transitory computer-readable storage medium of claim 11, wherein the plurality of categories comprises at least one of a geographical category, a terminal category, a network category, an end-user category, and a third-party cooperation unit category.
